(19) United States
(12) Patent Application Publication
(10) Pub. No.: US 2018/0014085 A1
(43) Pub. Date: Jan. 11, 2018

(54) Information Processing Apparatus, Information Processing Method, And Program

(71) Applicant: Sony Corporation, Tokyo (JP)

(72) Inventor: Hideo Nagasaka, Kanagawa (JP)

(73) Assignee: Sony Corporation, Tokyo (JP)

(21) Appl. No.: 15/547,143

(22) PCT Filed: Mar. 23, 2016
(86) PCT No.: PCT/JP2016/001660

§ 371 Date: Jul. 28, 2017

(30) Foreign Application Priority Data
Apr. 23, 2015 (JP) 2015-088176

(51) Int. Cl. H04N 21/81; H04N 21/45; H04N 21/442; H04N 21/658; H04N 21/2668

(52) U.S. Cl. CPC H04N 21/812; H04N 21/6582; H04N 21/2668; H04N 21/44204; H04N 21/4532

(57) ABSTRACT

An information processing apparatus may include circuitry configured to control: receiving first viewing information indicating a user viewing situation of a first advertisement content via broadcast signals determined from second viewing information using user identification information; and identifying a second advertisement content based on the first viewing information and a predetermined viewing time condition.

### CROSS REFERENCE TO RELATED APPLICATIONS

This application claims the benefit of Japanese Priority Patent Application JP 2015-088176 filed Apr. 23, 2015, the entire contents of which are incorporated herein by reference.

### TECHNICAL FIELD

The present disclosure relates to an information processing apparatus, an information processing method, and a program.

### BACKGROUND ART

There is a generally known method for causing a user to encounter advertisement content via a television video receiver, by broadcasting the advertisement content, such as a still image and a moving image by utilizing broadcast waves, as a method for causing a user to encounter the advertisement content.

Also, in recent years, a method has been established which delivers advertisement content via a network such as the Internet, as in what is called banner advertisement for example, as a method for causing a user to encounter the advertisement content. In particular, with respect to delivery of advertisement content via a network, a scheme is also studied which controls advertisement content of delivery target, according to a user of a delivery destination. For example, PTL 1 discloses an example of a scheme that controls related advertisement content to be delivered via the network, according to consumption behavior of a user.

### CITATION LIST

### Patent Literature

PTL 1: JP 2009-140255A

### SUMMARY

### Technical Problem

On the other hand, a user's encounter with advertisement content by utilizing broadcast waves depends on whether or not the user views the broadcast of the corresponding channel within a time slot within which the advertisement content is broadcasted, and thus is difficult to control intentionally in many cases.

Thus, in recent years, advertisement development (what is called advertisement development in cross media) utilizing different media is attracting attention as in broadcast utilizing broadcast waves and delivery via a network, and particularly a scheme capable of causing a user to encounter with advertisement content more efficiently is called for.

Thus, the present disclosure proposes an information processing apparatus, an information processing method, and a program capable of controlling a user's encounter with advertisement content, by causing broadcast of advertisement content utilizing broadcast waves and delivery of advertisement content via a network to cooperate with each other.

### Solution to Problem

According to an embodiment of the present disclosure, an information processing apparatus may include circuitry configured to control: receiving first viewing information indicating a user viewing situation of a first advertisement content via broadcast signals determined from second viewing information using user identification information; and identifying a second advertisement content based on the first viewing information and a predetermined viewing time condition.

According to an embodiment of the present disclosure, an information processing method may include controlling, by a processing device, receiving first viewing information indicating a user viewing situation of a first advertisement content via broadcast signals determined from second viewing information using user identification information; and identifying a second advertisement content based on the first viewing information and a predetermined viewing time condition.

According to an embodiment of the present disclosure, an information processing apparatus may include circuitry configured to control: extracting viewing information indicating a user viewing situation of a first advertisement content via broadcast waves, based on user identification information received by the apparatus; and outputting the viewing information for identifying a second advertisement content associated with the first advertisement content at a second apparatus, in which the second advertisement content is identified from the viewing information based on a predetermined viewing time condition.

According to an embodiment of the present disclosure, an information processing apparatus may include circuitry configured to control: transmitting, over a communication network, user identification information to a second apparatus, in which the second apparatus receives first viewing information indicating a user viewing situation of a first advertisement content via broadcast waves determined from second viewing information using the user identification information; and presenting, on a display device associated with the information processing apparatus, a second advertisement content received over the communication network, in which the second advertisement content is identified based on the first viewing information and a predetermined viewing time condition by the second apparatus.

### Advantageous Effects of Invention

As described above, according to an embodiment of the present disclosure, there is provided an information processing apparatus, an information processing method, and a program capable of controlling a user's encounter with advertisement content, by causing broadcast of advertisement content utilizing broadcast waves and delivery of advertisement content via a network to cooperate with each other.

Note that the effects described above are not necessarily limited, and along with or instead of the effects, any effect that is desired to be introduced in the present specification or other effects that can be expected from the present specification may be exhibited.

### BRIEF DESCRIPTION OF DRAWINGS

FIG. 1 is an explanatory diagram for describing an overview of an information processing system according to an embodiment of the present disclosure.

FIG. 2 is an explanatory diagram for describing an example of a system configuration of an information processing system according to the same embodiment.

FIG. 3 is a block diagram illustrating an example of a function and configuration of an information processing system according to the same embodiment.

FIG. 4 is a flowchart illustrating an example of a sequence of a series of processes of an information processing system according to the same embodiment.

FIG. 5 is an explanatory diagram for describing an example of a utilization situation of an information processing system according to the same embodiment.

FIG. 6 is a flowchart illustrating another example of a sequence of a series of processes of an information processing system according to the same embodiment.

FIG. 7 is an explanatory diagram for describing a working example of an information processing system according to the same embodiment.

FIG. 8 is a diagram illustrating an example of a hardware configuration of an information processing apparatus according to the same embodiment.

### DESCRIPTION OF EMBODIMENTS

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Note that description will be made in the following order.
1. Overview
2. Configuration
2.1. System Configuration
2.2. Function and Configuration
3. Process
3.1. Example of Control Based on Viewing Performance
3.2. Control Example Based on Viewing Prediction
4. Exemplary Variant
4.1. Exemplary Variant 1: Example of Record Information
4.2. Exemplary Variant 2: Example of Specifying Method of Delivery Target
4.3. Exemplary Variant 3: Utilization of Information Presented in Program
4.4. Exemplary Variant 4: Guidance to Broadcast Report Content
5. Working Example
6. Hardware Configuration
7. Conclusion

<1. Overview>

First, in order to make it easier to understand the feature of an information processing system according to an embodiment of the present disclosure, the problem of the information processing system according to the present embodiment is summarized, and then the overview of the information processing system will be described.

As an index for evaluating advertisement content broadcasted by utilizing broadcast waves (hereinafter, sometimes referred to as “broadcast advertisement content”), there is a known index that is called “advertisement awareness percentage” calculated by having an advertisement delivery target (hereinafter, sometimes referred to as “user”) view broadcast advertisement content actually and surveying whether or not the user is remembering the broadcast advertisement content.

It is known, from the result of the survey of this advertisement awareness percentage, that correlativity exists between the number of user's encounters with broadcast advertisement content and the advertisement awareness percentage of the broadcast advertisement content. Specifically, as the number of encounters with broadcast advertisement content increases, the advertisement awareness percentage of the broadcast advertisement content tends to increase, and when the number of encounters with the broadcast advertisement content exceeds a certain number, the advertisement awareness percentage tends to converge. Hence, it is known, from this tendency, that the number of times to cause a user to encounter with advertisement content and acknowledge the advertisement can be statistically calculated in some cases, for example.

Also, in recent years, a method is established which delivers advertisement content via a network such as the Internet, as in what is called banner advertisement for example, as a method for causing a user to encounter the advertisement content. In particular, with respect to delivery of advertisement content via a network, a scheme that controls the advertisement content of delivery target according to a user of delivery destination is also studied. Note that, in the following description, advertisement content delivered via a network such as the Internet is sometimes referred to as “web advertisement content”. Also, in the following description, such advertisement content is sometimes referred to as “advertisement content” simply, when broadcast advertisement content and web advertisement content are not distinguished particularly.

In particular, in recent years, advertisement development in what is called cross media is attracting attention as a scheme for causing a user to efficiently encounter with advertisement content, and particularly cooperation between broadcast of broadcast advertisement content and delivery of web advertisement content is attracting attention.

With respect to advertisement development in cross media, it is known that a more preferable ratio can exist, from a survey result of a relationship between ratios of broadcast advertisement content and web advertisement content (banner advertisement) and purchase intention creating effect, for example.

On the other hand, a user's encounter with advertisement content by utilizing broadcast waves (i.e., broadcast advertisement content) depends on whether or not the user views the broadcast of the corresponding channel within a time slot within which the advertisement content is broadcasted, and thus is difficult to control intentionally in many cases.

Thus, the information processing apparatus according to the present embodiment provides a scheme that can control the user's encounter with target advertisement content, by causing broadcast of advertisement content by utilizing broadcast waves and delivery of advertisement content via a network to cooperate more closely with each other.

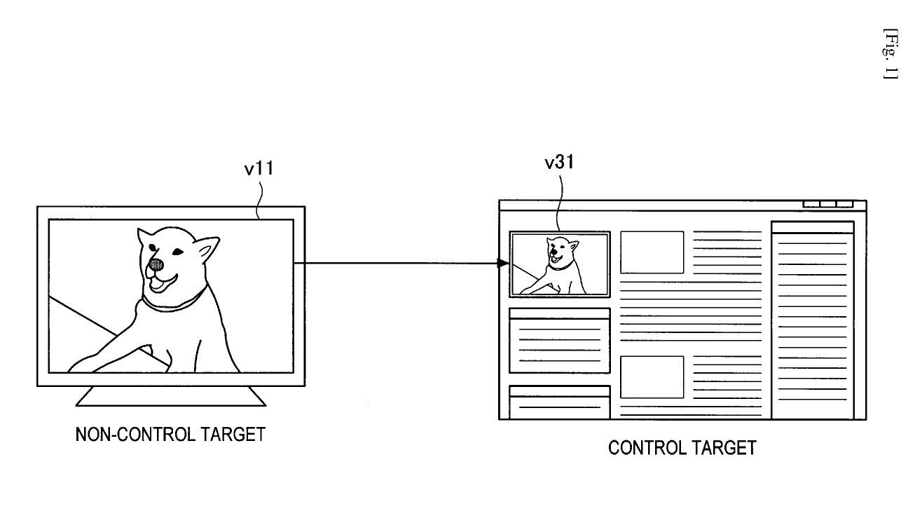

For example, FIG. 1 is an explanatory diagram for describing an overview of an information processing system according to the present embodiment. In FIG. 1, a reference sign v11 schematically illustrates broadcast advertisement content. Also, a reference sign v31 schematically illustrates web advertisement content, and schematically illustrates what is called a banner advertisement presented in an advertisement space on a web page displayed by a browser or the like for example, in the example illustrated in FIG. 1. Note that the presentation method of the web advertisement content v31 which is illustrated in FIG. 1 is just an example, and is not necessarily limited to what is called a banner advertisement.

The information processing system according to the present embodiment knows a viewing situation of broadcast advertisement content, by utilizing a viewing history recorded by a television video receiver, a device (what is called a recorder) that records in the recording medium the content (broadcast content) broadcasted by utilizing broadcast waves, or the like, for example. Note that the viewing situation of the broadcast advertisement content is, for example, what is called a viewing performance, such as when a user views target broadcast advertisement content and how many times a user views target broadcast advertisement content.

The information processing system according to the present embodiment controls the user's encounter with intended advertisement content, by controlling the delivery of the web advertisement content to a target user on the basis of the viewing performance of the known broadcast advertisement content.

For example, the information processing system according to the present embodiment controls the number of deliveries of the web advertisement content to a network terminal (for example, smartphone, etc.) operated by a user, on the basis of the number of user's encounters with the recognized broadcast advertisement content, with respect to a predetermined advertisement content.

For example, the information processing system may control the number of deliveries of the web advertisement content, in such a manner that the summation of the number of user's encounters with each of the broadcast advertisement content and the web advertisement content related to the broadcast advertisement content becomes a predetermined number of times. In this case, the information processing system may control the number of deliveries of the web advertisement content to a user terminal, according to the recognition result of the number of encounters (in other words, the number of viewing times) of the user with the broadcast advertisement content. Note that the information processing system may acquire information for identifying a user that operates each terminal, from the terminal by utilizing the control information such as cookie, for example.

Also, the information processing system may control the number of deliveries of the web advertisement content, in such a manner that the proportion of the number of user's encounters with the web advertisement content to the number of user's encounters with the broadcast advertisement content becomes a predetermined value.

Also, as another example, the information processing system may control the user's encountering time point with the web advertisement content related to the broadcast advertisement content, according to the user's encountering time point with the broadcast advertisement content.

For example, the information processing system may control a web advertisement content delivering time point, in such a manner that the user encounters the web advertisement content associated with a certain broadcast advertisement content within a predetermined period from the user's encountering time point with the broadcast advertisement content. In this case, the information processing system may control the web advertisement content delivering time point to a user terminal, according to the recognition result of the user's encountering time point (in other words, viewing date and time) with the broadcast advertisement content.

As described above, the information processing system according to the present embodiment controls the user's encounter with the corresponding advertisement content, by setting the delivery of the web advertisement content as a control target (note that the broadcast of the broadcast advertisement content becomes a non-control target). That is, the information processing apparatus according to the present embodiment controls the user's encounter with the target advertisement content, by causing the broadcast of the broadcast advertisement content and the delivery of the web advertisement content to cooperate more closely with each other. This control enables the information processing system according to the present embodiment to execute a control in such a manner that the target user of the advertisement content efficiently encounters intended advertisement content. In the following, the information processing system according to the present embodiment will be described in more detail.

<2. Configuration>

{2.1. System Configuration}

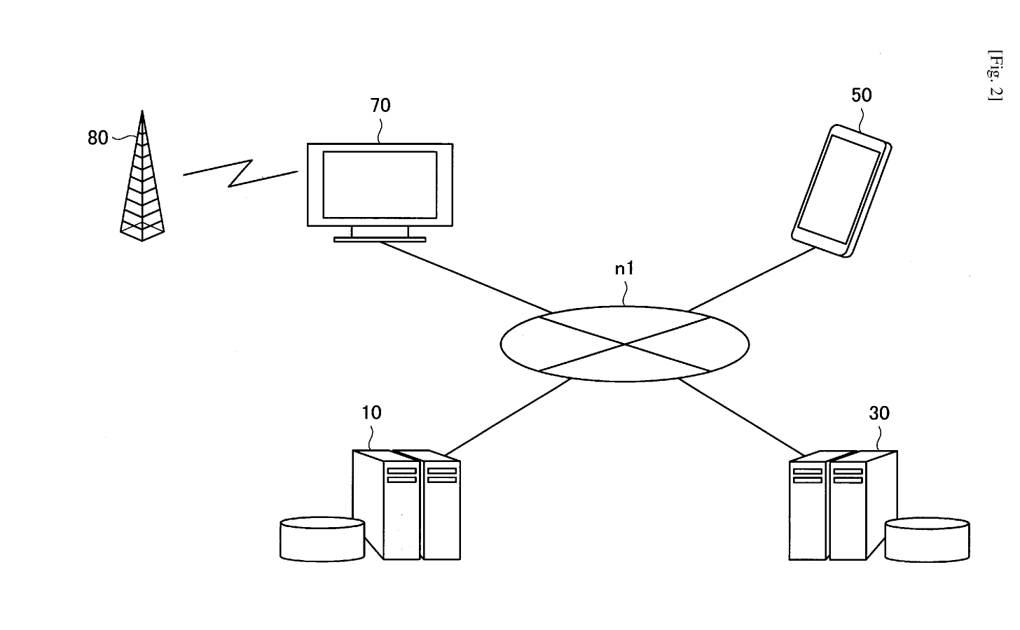

The configuration of the information processing system according to the present embodiment will be described. First, with reference to FIG. 2, an example of the system configuration of the information processing system according to the present embodiment will be described. FIG. 2 is an explanatory diagram for describing an example of the system configuration of the information processing system according to the present embodiment.

As illustrated in FIG. 2, the information processing system according to the present embodiment includes a broadcast receiver 70, a user terminal 50, a log management server 10, and an advertisement delivery server 30. The broadcast receiver 70, the user terminal 50, the log management server 10, and the advertisement delivery server 30 are connected via a network n1.

The network n1 is not limited to a specific form, if it is a network that connects different devices, such as the Internet, a dedicated line, a local area network (LAN), or a wide area network (WAN), for example. Also, the network n1 may be implemented as a wired or wireless network. Also, the network n1 may include a plurality of networks, and may include both of the wireless network and the wired network.

The broadcast receiver 70 is a device configured to receive the content (the broadcast content) broadcasted by utilizing broadcast waves from the broadcast station 80, and corresponds to a television video receiver, a recorder for recording broadcast content, or the like, for example. Also, the broadcast receiver 70 according to the present embodiment is configured to record a viewing history of the broadcast content by the user as record information. As a specific example, the broadcast receiver 70 records, as the record information, the broadcast date and time of the broadcast content viewed by the user, and the history of the information indicating the channel through which the broadcast content is broadcasted.

Also, the broadcast receiver 70 may record, as the record information, the information (hereinafter, sometimes referred to as “viewing prediction”) of the broadcast content that is predicted to be viewed in future by the user. As a specific example, the broadcast receiver 70 may record, as the record information, the information (for example, broadcast date and time and channel, etc.) of the broadcast that is predicted to be viewed in future by the user, on the basis of the information of the broadcast habitually viewed by the user (for example, day of week, time slot, and channel in which the broadcast content habitually viewed is broadcasted, etc.) on the basis of the viewing history. Also, the broadcast receiver 70 may record, as the record information, the information of the broadcast that is predicted to be viewed in future by the user, on the basis of information of timer recording.

Also, in the information processing system according to the present embodiment, identification information (for example, user ID) of each user (for example, the owner of the broadcast receiver 70) is assigned in advance to the broadcast receiver 70. The broadcast receiver 70 associates the recorded record information with the identification information, and transmits it to the log management server 10 described later. Thereby, the log management server 10 recognizes the broadcast advertisement content viewed by the user corresponding to the identification information, and the broadcast advertisement content that is predicted to be viewed by the user, on the basis of the acquired record information.

Also, the broadcast receiver 70 may announce the identification information assigned to itself, to the user terminal 50 associated in advance. As a specific example, the broadcast receiver 70 may announce the identification information to the user terminal 50 with which the connection of the communication is established. Also, the broadcast receiver 70 may execute what is called an authentication process with the connected user terminal 50, and announce the identification information to the user terminal 50, when succeeding in the authentication process.

Note that it is also envisaged that the broadcast receiver 70 is shared by a plurality of users, as in a case in which the broadcast receiver 70 is shared by a family. Hence, the broadcast receiver 70 may identify the user that views the broadcast content, and record record information, such as viewing performance, for each user on the basis of the identification result. Note that, in this case, the broadcast receiver 70 may assign identification information different from each other to each user, and may announce only the identification information corresponding to the user of the user terminal 50, to the user terminal 50. Also, it is needless to say that the method is not limited particularly, if the broadcast receiver 70 is capable of identifying the user that views the broadcast content. As a specific example, the broadcast receiver 70 may capture an image of the user that views the broadcast content, by means of the imaging unit or the like, and identify the user by performing analysis based on the technology that identifies the individual user, such as the face recognition technology for example, with respect to the captured image.

The user terminal 50 is a terminal, such as a personal computer (PC), a smartphone, and a tablet terminal, that allows the user to view various types of content (for example, content posted on a web site or the like, etc.) by connecting to a network such as the Internet. Also, the user terminal 50 may be configured to execute various types of functions (for example, application) that can access the network n1. Note that the function is, for example, a function for reproducing moving image content delivered via the network n1, a function for accessing various types of services such as what is called social networking service (SNS), or the like.

Also, in the information processing system according to the present embodiment, the user terminal 50 acquires the identification information from the broadcast receiver 70, and transmits the acquired identification information to the advertisement delivery server 30 described later. Then, the user terminal 50 receives the web advertisement content corresponding to the identification information, from the advertisement delivery server 30. Thereby, for example, the user terminal 50 presents the web advertisement content received from the advertisement delivery server 30, in a predetermined advertisement space, as in what is called banner advertisement.

The log management server 10 acquires the record information from the broadcast receiver 70, and generates viewing information indicating the viewing situation of the broadcast advertisement content of the user (for example, the owner of the broadcast receiver 70) corresponding to the broadcast receiver 70, on the basis of the acquired record information, and manages the viewing situation for each user.

Also, the log management server 10 receives the request from the advertisement delivery server 30, and outputs as a response the viewing information corresponding to the condition designated in the request, to the advertisement delivery server 30. As a specific example, the log management server 10 may receive the request in which the identification information (i.e., the user) is designated, from the advertisement delivery server 30, and output as a response the viewing information corresponding to the identification information, to the advertisement delivery server 30. Note that the detail of the log management server 10 will be described later in a separate manner.

The advertisement delivery server 30 is a device for delivering various types of web advertisement content to the user terminal 50.

The advertisement delivery server 30 acquires the identification information from the user terminal 50, and acquires from the log management server 10 the information indicating the viewing situation of each broadcast advertisement content of the user corresponding to the identification information. The advertisement delivery server 30 extracts candidates (for example, the broadcast advertisement content) of the advertisement content of the presentation target of the web advertisement content to the user, on the basis of the acquired information indicating the viewing situation of each broadcast advertisement content. Thereafter, the advertisement delivery server 30 specifies the advertisement content of the delivery target of the web advertisement content, on the basis of a condition determined in advance, from among the candidates of the extracted advertisement content. Then, the advertisement delivery server 30 delivers the web advertisement content corresponding to the specified advertisement content (i.e., the web advertisement content associated with the broadcast advertisement content narrowed down according to the viewing situation), to the user terminal 50 which is the acquisition source of the identification information. Note that the detail of the advertisement delivery server 30 will be described later in a separate manner.

In the above, with reference to FIG. 2, an example of the system configuration of the information processing system according to the present embodiment has been described. The above configuration enables the information processing system according to the present embodiment to control the user's encounter with intended advertisement content, by controlling the delivery of the web advertisement content associated with the broadcast advertisement content, according to the viewing situation of the broadcast advertisement content.

{2.2. Function and Configuration}

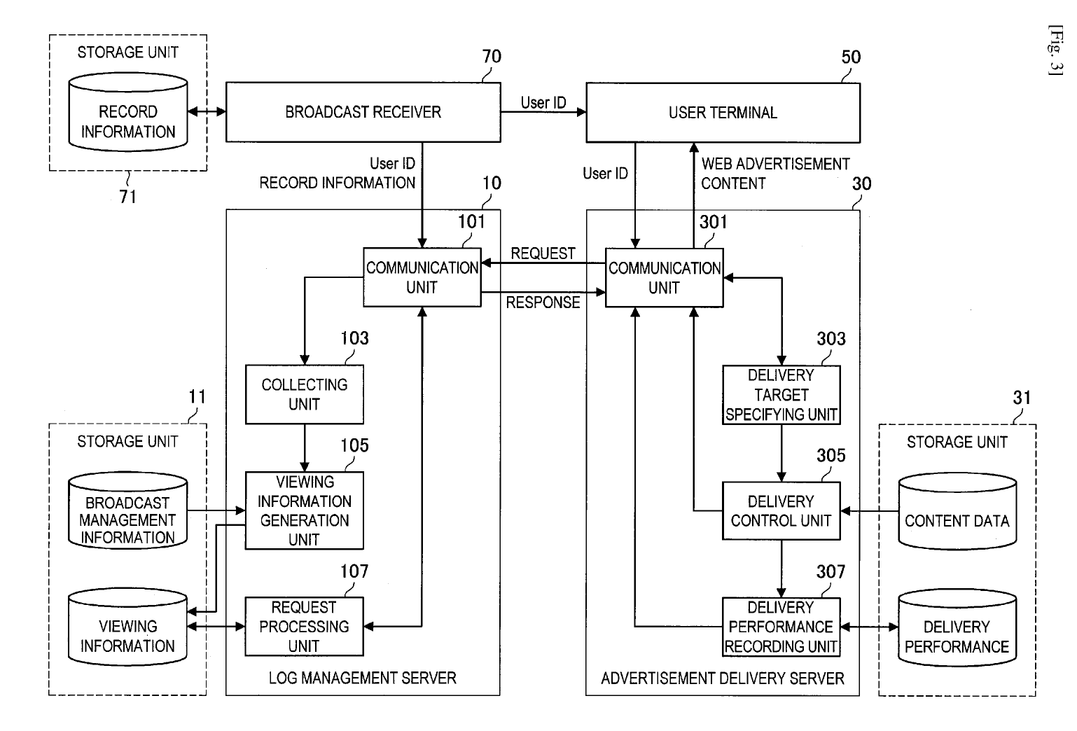

Next, with reference to FIG. 3, an example of the function and configuration of the information processing system according to the present embodiment will be described. FIG. 3 is a block diagram illustrating an example of the function and configuration of the information processing system according to the present embodiment. Note that, in the present description, detailed configuration will be described with respect to the log management server 10 and the advertisement delivery server 30.

The broadcast receiver 70 stores the viewing history of the broadcast content and the viewing prediction of the broadcast content in the storage unit 71 as the record information, for example. Note that the storage unit 71 may be equipped in the broadcast receiver 70, and may be attached to the outside of the broadcast receiver 70.

The broadcast receiver 70 transmits the record information stored in the storage unit 71, to the log management server 10, together with the identification information (for example, the user ID) assigned to itself in advance.

Also, the broadcast receiver 70 announces the identification information assigned to itself, to the user terminal 50 connected via the network n1. Note that the user terminal 50 transmits the identification information announced from the broadcast receiver 70, to the advertisement delivery server 30. Thereby, the user terminal 50 receives the web advertisement content corresponding to the identification information (for example, the web advertisement content specified according to the viewing situation of the broadcast advertisement content of the user corresponding to the identification information), from the advertisement delivery server 30.

Note that the broadcast receiver 70 in the information processing system according to the present embodiment is needless to be configured as a television video receiver and what is called a recorder necessarily, if it can provide the function described above. As a specific example, the broadcast receiver 70 according to the present embodiment may be configured as a server connected to the television video receiver and what is called the recorder.

(Log Management Server 10)

Next, the configuration of the log management server 10 will be described. As illustrated in FIG. 3, the log management server 10 includes a communication unit 101, a collecting unit 103, a viewing information generation unit 105, and a request processing unit 107. Also, the log management server 10 is configured to access the storage unit 11.

The storage unit 11 is a storage region for storing various types of information (data) used by the log management server 10. The storage unit 11 may be equipped in the log management server 10, and may be attached to the outside of the log management server 10.

The communication unit 101 is a component to allow each component in the log management server 10 to establish the communication via the network n1 with the external device (for example, the broadcast receiver 70 and the advertisement delivery server 30) and to transmit to and receive from the external device various types of information (various types of data). Note that, in the following description, each component in the log management server 10 is assumed to perform transmission and reception of the information via the communication unit 101, when performing the transmission and reception of the information with the external device via the network nl, even when there is no particular description.

The collecting unit 103 acquires the record information (i.e., the viewing history and the viewing prediction of the broadcast content) managed by the broadcast receiver 70 and the identification information assigned to the broadcast receiver 70, from the broadcast receiver 70. In this case, the collecting unit 103 may actively acquire the record information and the identification information from the broadcast receiver 70, by instructing the transmission of the record information and the identification information to the broadcast receiver 70. Also, as another example, the collecting unit 103 may passively acquire the record information and the identification information that the broadcast receiver 70 actively transmits. Note that the collecting unit 103 may acquire the record information and the identification information, from each of a plurality of broadcast receivers 70.

Then, the collecting unit 103 outputs the record information acquired from the broadcast receiver 70 to the viewing information generation unit 105, for each identification information.

The viewing information generation unit 105 acquires the record information collected by the collecting unit 103, from the collecting unit 103, for each identification information. Also, the viewing information generation unit 105 reads the broadcast management information stored in the storage unit 11 in advance. The broadcast management information includes information of each broadcast advertisement content broadcasted in the past (hereinafter, sometimes referred to as “broadcast performance”), and information of each broadcast advertisement content that is scheduled to be broadcasted in future (hereinafter, sometimes referred to as “broadcast schedule”). Note that the broadcast performance includes information indicating broadcast date and time and broadcast channel of the broadcast advertisement content broadcasted in the past, for example. Also, the broadcast schedule includes information indicating broadcast date and time and broadcast channel of the broadcast advertisement content that is scheduled to be broadcasted in future, for example. Note that the broadcast management information may be generated in advance and updated on the basis of the broadcast schedule and the broadcast performance of the broadcast content (for example, the broadcast advertisement content) by each broadcast station at each predetermined timing, for example.

The viewing information generation unit 105 generates or updates the viewing information including the viewing performance and the viewing prediction of each broadcast advertisement content, on the basis of the record information acquired for each identification information and the broadcast management information read from the storage unit 11.

As a specific example, the viewing information generation unit 105 compares the viewing history included in the record information acquired for each identification information (i.e., broadcast date and time and channel of the broadcast content viewed by the user), with the broadcast performance of each broadcast content included in the broadcast management information, and acquires the viewing performance of each broadcast advertisement content as a comparison result. Note that the viewing performance acquired in this case includes information relevant to each broadcast advertisement content viewed in the past by the user, which is indicated by the identification information, that is, information indicating the broadcast date and time of the broadcast advertisement content and the channel through which the broadcast advertisement content is broadcasted.

Also, as another example, the viewing information generation unit 105 compares the viewing prediction included in the record information acquired for each identification information (i.e., the broadcast date and time and the channel of the broadcast content that is predicted to be viewed by the user), with the broadcast schedule of each broadcast content included in the broadcast management information, and acquires the viewing prediction of each broadcast advertisement content as a comparison result. Note that the viewing prediction acquired in this case includes information relevant to each broadcast advertisement content that is predicted to be viewed in future by the user indicated by the identification information, that is, the information indicating the broadcast date and time of the broadcast advertisement content and the channel through which the broadcast advertisement content is broadcasted.

As described above, the viewing information generation unit 105 acquires information indicating the viewing performance and the viewing prediction of each broadcast advertisement content for each identification information on the basis of the record information and the broadcast management information, and generates or updates the viewing information on the basis of the acquired information. That is, the viewing information includes the information indicating the viewing performance and the viewing prediction of each broadcast advertisement content by the user, for each user indicated by the identification information. Note that the viewing information generation unit 105 may store the generated or updated viewing information in the storage unit 11. Note that, in the following description, the generated or updated viewing information is stored in the storage unit 11.

The request processing unit 107 acquires a request via the network n1 from the advertisement delivery server 30, and searches the storage unit 11 for the viewing information identical with the condition indicated by the request, and extracts the information indicating the viewing situation from the viewing information. Then, the request processing unit 107 transmits the extraction result of the information indicating the viewing situation, as a response, to the transmission source of the request. Note that the request processing unit 107 corresponds to an example of “output unit”.

As a specific example, it is assumed that the request processing unit 107 receives an instruction according to the extraction of the viewing performance of the user corresponding to an intended identification information, as the request, from the advertisement delivery server 30. In this case, the request processing unit 107 acquires the target identification information from the advertisement delivery server 30, and searches the storage unit 11 for the viewing information associated with the acquired identification information. Then, the request processing unit 107 extracts the information indicating the viewing performance of each broadcast advertisement content from the searched viewing information, and transmits the extracted information, as a response to the request, to the advertisement delivery server 30 which is the transmission source of the request.

As another example, it is assumed that the request processing unit 107 receives an instruction according to the extraction of the viewing prediction of the user corresponding to an intended identification information, as the request, from the advertisement delivery server 30. In this case, the request processing unit 107 acquires the target identification information from the advertisement delivery server 30, and searches the storage unit 11 for the viewing information associated with the acquired identification information. Then, the request processing unit 107 extracts the information indicating the viewing prediction of each broadcast advertisement content from the searched viewing information, and transmits the extracted information, as a response to the request, to the advertisement delivery server 30 which is the transmission source of the request.

Also, as another example, the request processing unit 107 may acquire, from the advertisement delivery server 30, the condition for the extraction of the viewing information and the designation of the condition of the information that is output as the response, as the request. In this case, the request processing unit 107 controls the extraction of the viewing information from the storage unit 11, and the form of the information that is transmitted as the response to the advertisement delivery server 30 which is the transmission source of the request, on the basis of the designated condition.

For example, the request processing unit 107 may count the number of viewing times of the past for each broadcast advertisement content, on the basis of the viewing performance included in the viewing information extracted on the basis of the request, and transmit the count result as the response to the advertisement delivery server 30. In the same way, the request processing unit 107 may count the number of times of predicted viewing for each broadcast advertisement content on the basis of the viewing prediction included in the extracted viewing information, and transmit the count result as the response to the advertisement delivery server 30.

Also, as another example, the request processing unit 107 may receive the designation of the target broadcast advertisement content as the request, and extracts the information indicating the viewing situation (the viewing performance or the viewing prediction) of the broadcast advertisement content, and transmit the extraction result as the response, to the advertisement delivery server 30 which is the transmission source of the request.

Also, the request processing unit 107 may update the viewing information stored in the storage unit 11, on the basis of the request from the advertisement delivery server 30.

As a specific example, it is assumed that the request processing unit 107 acquires the information indicating the delivery performance of the web advertisement content as well as the request of the update of the viewing information, for each identification information, from the advertisement delivery server 30. In this case, the request processing unit 107 extracts the viewing information associated with the identification information from the storage unit 11, and extracts the information indicating the viewing performance and the viewing prediction of the broadcast advertisement content associated with the web advertisement content whose delivery performance is acquired, from the extracted viewing information. Then, the request processing unit 107 updates the viewing information in such a manner that the acquired information indicating the delivery performance is associated with the information indicating the extracted viewing performance and viewing prediction. Thereby, the management of the viewing performance and the viewing prediction of the broadcast advertisement content and the delivery performance of the web advertisement content associated with the broadcast advertisement content is unified.

As a matter of course, the request processing unit 107 may set the delivery performance as the target of the information extraction based on the request, when the delivery performance of the web advertisement content is associated with the viewing performance and the viewing prediction of the broadcast advertisement content. As a specific example, the request processing unit 107 may count the summation of the number of viewing times of the broadcast advertisement content and the web advertisement content, and output the count result.

(Advertisement Delivery Server 30)

Next, the configuration of the advertisement delivery server 30 will be described. As illustrated in FIG. 3, the advertisement delivery server 30 includes a communication unit 301, a delivery target specifying unit 303, a delivery control unit 305, and a delivery performance recording unit 307. Also, the advertisement delivery server 30 is configured to access the storage unit 31.

The storage unit 31 is a storage region for storing various types of content (i.e., web advertisement content) that the advertisement delivery server 30 delivers and various types of information (data) used by the advertisement delivery server 30. Note that the web advertisement content stored in the storage unit 31 is associated in advance with the corresponding broadcast advertisement content (for example, the broadcast advertisement content of the same article and the same maker). Also, the storage unit 31 may be equipped in the advertisement delivery server 30, and may be attached to the outside of the advertisement delivery server 30.

The communication unit 301 is a component to allow each component in the advertisement delivery server 30 to establish the communication via the network n1 with the external device (for example, the user terminal 50 and the log management server 10) and to transmit to and receive from the external device various types of information (various types of data). Note that, in the following description, each component in the advertisement delivery server 30 is assumed to perform transmission and reception of the information via the communication unit 301, when performing the transmission and reception of the information with the external device via the network n1, even when there is no particular description.

The delivery target specifying unit 303 decides the web advertisement content delivered to the user terminal 50, according to the viewing situation (for example, the viewing history and the viewing performance) of the broadcast advertisement content by the user of the user terminal 50.

Specifically, the delivery target specifying unit 303 first acquires the identification information corresponding to the user of the user terminal 50, from the user terminal 50 of the delivery target of the web advertisement content. The delivery target specifying unit 303 generates a request for acquiring the information indicating the viewing situation (for example, the viewing performance and the viewing prediction) of the broadcast advertisement content, by the user corresponding to the identification information, on the basis of the acquired identification information.

The delivery target specifying unit 303 transmits the generated request to the log management server 10, and acquires the information indicating the viewing situation corresponding to the request, as a response, from the log management server 10. As described above, the delivery target specifying unit 303 recognizes the viewing situation (i.e., the viewing performance and the viewing prediction) of each broadcast advertisement content by the user indicated by the identification information, on the basis of the information acquired from the log management server 10.

Thereafter, the delivery target specifying unit 303 specifies the web advertisement content of the delivery target to the user terminal 50 which is the acquisition source of the identification information, on the basis of the recognition result of the viewing situation of each broadcast advertisement content by the user indicated by the identification information.

Specifically, first, the delivery target specifying unit 303 extracts candidates of the advertisement content whose web advertisement content associated with the broadcast advertisement content is the delivery target, on the basis of a predetermined condition, from the recognition result of the viewing situation of each broadcast advertisement content.

For example, the delivery target specifying unit 303 may extract the candidates of the advertisement content whose corresponding web advertisement content is the delivery target, on the basis of the number of viewing times of each broadcast advertisement content.

As a specific example, the delivery target specifying unit 303 may extract, from among the advertisement content whose summation of viewing times of the broadcast advertisement content and the web advertisement content is set in advance, the advertisement content whose number of viewing times of the broadcast advertisement content does not reach the summation of viewing times. The summation of viewing times of the broadcast advertisement content and the web advertisement content can be controlled to be a predetermined number of times, by utilizing this extraction result, for example.

Also, as another example, the delivery target specifying unit 303 may extract the advertisement content having the viewing performance of the broadcast advertisement content, from among the advertisement content whose proportion of the number of encounters with the web advertisement content to the number of encounters with the broadcast advertisement content is set in advance. The proportion of the number of encounters with the web advertisement content to the number of encounters with the broadcast advertisement content can be controlled to be a predetermined proportion, by utilizing this extraction result, for example.

Also, as another example, the delivery target specifying unit 303 may extract the advertisement content whose broadcast advertisement content is not viewed (i.e., the number of viewing times is 0). A control is performed in such a manner that the user who has not encountered the broadcast advertisement content encounters the web advertisement content, by utilizing this extraction result, for example.

Note that, when the number of viewing times of each broadcast advertisement content is the benchmark, the delivery target specifying unit 303 may calculate the number of viewing times on the basis of a series of viewing performances of the corresponding broadcast advertisement content, and may calculate the number of viewing times on the basis of the viewing performance within a period determined in advance (for example, the period from the present moment to one month before, etc.).

Also, the delivery target specifying unit 303 may extract the candidates of the advertisement content whose corresponding web advertisement content is the delivery target, on the basis of the viewing time point of each broadcast advertisement content.

As a specific example, the delivery target specifying unit 303 may extract the advertisement content whose elapsed time from the encountering time point with the broadcast advertisement content does not reach a period determined in advance. By utilizing this extraction result, a control is performed in such a manner that the user encounters with the web advertisement content corresponding to the broadcast advertisement content within a predetermined period from the encountering time point with the broadcast advertisement content, for example.

Also, as another example, the delivery target specifying unit 303 may extract the advertisement content for which the user's encounter with the broadcast advertisement content within a period determined in advance is predicted. By utilizing this extraction result, for example, a control is performed in such a manner that the user who is predicted to encounter the broadcast advertisement content encounters with the web advertisement content corresponding to the broadcast advertisement content in advance.

Also, the delivery target specifying unit 303 may manage attribute information, such as age, gender, and occupation of the user, with the identification information of each user, and narrow down the candidates of the advertisement content whose web advertisement content is the delivery target, on the basis of the attribute information.

Specifically, each advertisement content is associated with the attribute information of the user of the delivery target of the advertisement content in advance. The delivery target specifying unit 303 may narrow down the advertisement content of the delivery target of the web advertisement content, by comparing the attribute information of the user indicated by the acquired identification information with the attribute information associated with each advertisement content. By performing this narrowing down, a control is performed in such a manner that the target user of the advertisement content encounters each advertisement content.

Note that the above described condition for specifying the candidates of the advertisement content whose web advertisement content is the delivery target is just an example, and its detail is not limited particularly, if the target advertisement content is extractable on the basis of the advertisement strategy of each advertisement content. As a matter of course, various types of conditions described above may be combined as appropriate. As a specific example, the delivery target specifying unit 303 may narrow down the candidates of the target advertisement content, on the basis of the viewing time point of each broadcast advertisement content, from among the candidates of the advertisement content extracted on the basis of the number of viewing times of each broadcast advertisement content.

As described above, the delivery target specifying unit 303 extracts the candidates of the advertisement content whose web advertisement content is the delivery target, and specifies the advertisement content of the delivery target of the web advertisement content from among the extracted candidates.

Note that the delivery target specifying unit 303 may receive in advance a bidding from the advertiser for each advertisement content, and specify the advertisement content of the delivery target of the web advertisement content, on the basis of the information relevant to the bidding for each candidates, from among the candidates of the extracted advertisement content.

Upon specifying the advertisement content according to the viewing situation of each broadcast advertisement content, the delivery target specifying unit 303 specifies the web advertisement content corresponding to the advertisement content (in other words, the web advertisement content associated with the broadcast advertisement content narrowed down on the basis of a predetermined condition), as the delivery target to the user terminal 50 which is the acquisition source of the identification information. Then, the delivery target specifying unit 303 announces the information indicating the web advertisement content specified as the delivery target, and the information of the user terminal 50 of the delivery destination of the web advertisement content (i.e., the user terminal 50 of the acquisition source of the identification information), to the delivery control unit 305.

The delivery control unit 305 receives an announcement indicating the information indicating the web advertisement content of the delivery target, and the information of the user terminal 50 of the delivery destination of the web advertisement content, from the delivery target specifying unit 303.

The delivery control unit 305 reads the data of the web advertisement content of the delivery target from the storage unit 31 on the basis of the announcement from the delivery target specifying unit 303. Then, the delivery control unit 305 delivers the data of the web advertisement content read from the storage unit 31, to the user terminal 50 announced from the delivery target specifying unit 303. Thereby, the user terminal 50 acquires the web advertisement content specified according to the viewing situation of the broadcast advertisement content of the user indicated by the identification information, as a reply to the identification information transmitted to the advertisement delivery server 30, from the advertisement delivery server 30.

Also, the delivery control unit 305 may announce the information indicating the delivery performance (for example, the delivery date and time) of the web advertisement content, to the delivery performance recording unit 307 for each identification information.

The delivery performance recording unit 307 acquires the information indicating the delivery performance of each web advertisement content, for each identification information, from the delivery control unit 305, and records the acquired information indicating the delivery performance for each identification information. In this case, the delivery performance recording unit 307 may store the information indicating the delivery performance of each identification information, in the storage unit 31, for example.

Also, the delivery performance recording unit 307 may transmit to the log management server 10 the information indicating the delivery performance of the web advertisement content recorded for each identification information, and request an update of the viewing information based on the delivery performance to the log management server 10. Note that the configuration of the delivery performance recording unit 307 that transmits the information indicating the delivery performance of the web advertisement content to the log management server 10 corresponds to an example of “announcing unit”. Thereby, the log management server 10 unifies the management of the delivery performance of the web advertisement content transmitted from the delivery performance recording unit 307, in association with the viewing performance and the viewing prediction of the broadcast advertisement content associated with the web advertisement content.

Note that the delivery deadline may be set explicitly to the web advertisement content. As a specific example, it is supposed that the broadcast advertisement content of a certain specific campaign is meaningless, even if the user encounter the advertisement content at the end of the campaign.

Hence, by setting the delivery deadline to the web advertisement content, the advertisement delivery server 30 may utilize the delivery deadline set to the web advertisement content, for the purpose of narrowing down of the candidates of the web advertisement content of the delivery target, for example.

As a specific example, the advertisement delivery server 30 may preferentially specify the web advertisement content close to the delivery deadline, as the delivery target. Also, as another example, the advertisement delivery server 30 may exclude the web advertisement content that has passed the delivery deadline, from the candidates of the delivery target.

Also, as described above, the user's encounter with the broadcast advertisement content is difficult to control. Hence, it can be envisaged that the delivery time period of the web advertisement content associated with the broadcast advertisement content has ended, depending on the user's encountering time point with the broadcast advertisement content. Hence, the advertisement delivery server 30 may specify another web advertisement content related to the web advertisement content, when unable to specify the web advertisement content associated with the broadcast advertisement content.

As a specific example, the advertisement delivery server 30 may specify another web advertisement content of the product, when unable to specify the web advertisement content relevant to the campaign on the basis of the viewing performance of the broadcast advertisement content relevant to the campaign of a certain product.

In this case, for example, the advertisement delivery server 30 may classify a plurality of pieces of advertisement content into each group, in addition to the management of each advertisement content, and manage advertisement content of each group, by using the group ID or the like. Thereby, the advertisement delivery server 30 may specify another web advertisement content included in the same group as the web advertisement content, when unable to specify the web advertisement content of the target, for example.

Also, the identification information of each user transmitted and received between the log management server 10, the advertisement delivery server 30, the user terminal 50, and the broadcast receiver 70 is needless to be the same identification information necessarily, if each component can recognize the corresponding user. For example, the identification information transmitted and received between the advertisement delivery server 30 and the user terminal 50 and the identification information transmitted and received between the advertisement delivery server 30 and the log management server 10 may be different identification information in its detail, if associated with the same user.

In the above, with reference to FIG. 3, an example of the function and configuration of the information processing system according to the present embodiment has been described. As described above, the information processing system according to the present embodiment controls the delivery of the web advertisement content associated with the broadcast advertisement content, according to the viewing situation of each broadcast advertisement content. This configuration enables the information processing system according to the present embodiment to control the user's encounter with the related advertisement content, by controlling the delivery of the web advertisement content, even under the situation in which it is difficult to control the user's encounter with the broadcast advertisement content. Thereby, the information processing system according to the present embodiment allows the broadcast of the broadcast advertisement content and the delivery of the web advertisement content to cooperate more closely to cause the user to encounter the advertisement content more efficiently.

<3. Process>

Next, an example of the sequence of a series of processes of the information processing system according to the present embodiment will be described.

{3.1. Example of Control Based on Viewing Performance}

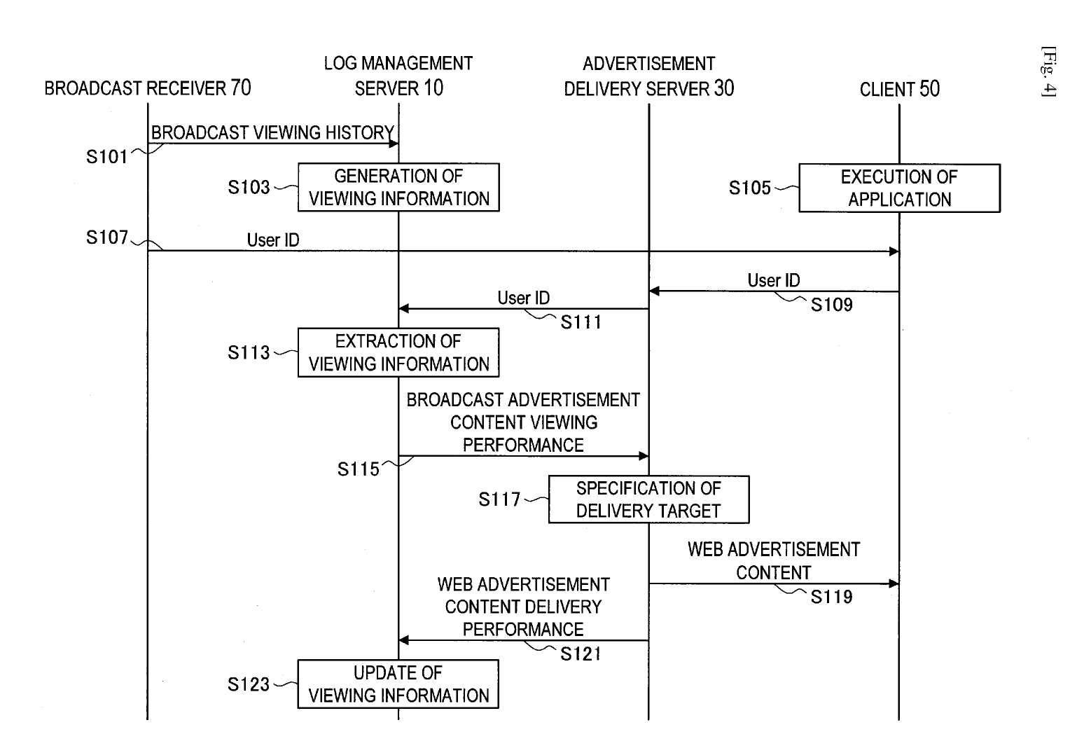

First, with reference to FIG. 4, an example of a sequence of a series of processes of the information processing system, when delivering the corresponding web advertisement content to the user terminal 50 on the basis of the viewing performance of the past of the broadcast advertisement content will be described. FIG. 4 is a flowchart illustrating an example of a sequence of a series of processes of the information processing system according to the present embodiment, and illustrates an example of the operation when delivering the corresponding web advertisement content on the basis of the viewing performance of the past of the broadcast advertisement content.

(Step S101)

The broadcast receiver 70 records, as the record information, the viewing history such as the information indicating the broadcast date and time of the broadcast content viewed by the user and the channel through which the broadcast content is broadcasted. Also, the identification information of each user is assigned to the broadcast receiver 70 in advance. The broadcast receiver 70 transmits the recorded record information (i.e., the viewing history of the broadcast advertisement content) to the log management server 10, in association with the identification information.

The collecting unit 103 of the log management server 10 acquires the record information (i.e., the viewing history of the broadcast content) managed by the broadcast receiver 70, and the identification information assigned to the broadcast receiver 70, from the broadcast receiver 70. The collecting unit 103 outputs the record information acquired from the broadcast receiver 70, to the viewing information generation unit 105, for each identification information.

(Step S103)

The viewing information generation unit 105 acquires the record information collected by the collecting unit 103 from the collecting unit 103 for each identification information. Also, the viewing information generation unit 105 reads the broadcast management information indicating the broadcast performance of each broadcast advertisement content broadcasted in the past and stored in advance in the storage unit 11. Note that the broadcast performance includes the information indicating the broadcast date and time and the broadcast channel of the broadcast advertisement content broadcasted in the past, for example.

The viewing information generation unit 105 generates or updates the viewing information including the viewing performance of each broadcast advertisement content, on the basis of the record information acquired for each identification information and the broadcast management information read from the storage unit 11. Then, the viewing information generation unit 105 stores the generated or updated viewing information in the storage unit 11.

(Step S105)

The user terminal 50 acquires various types of content (for example, content posted on a web site or the like, etc.) via a network such as the Internet in response to the operation from the user, and executes various types of functions for presenting the acquired content to the user. Note that the function is, for example, a function for reproducing moving image content delivered via the network, a function for accessing various types of service such as what is called SNS, or the like.

(Step S107)

Also, the broadcast receiver 70 announces the identification information assigned to itself, to the user terminal 50 associated in advance.

(Step S109)

The user terminal 50 acquires the identification information from the broadcast receiver 70, and transmits the acquired identification information to the advertisement delivery server 30.

(Step S111)

The delivery target specifying unit 303 of the advertisement delivery server 30 acquires the identification information corresponding to the user of the user terminal 50, from the user terminal 50 of the delivery target of the web advertisement content. The delivery target specifying unit 303 generates a request for acquiring the information indicating the viewing performance of the broadcast advertisement content, by the user corresponding to the identification information, on the basis of the acquired identification information, and transmits the request to the log management server 10.

(Step S113)

The request processing unit 107 of the log management server 10 acquires the instruction of the extraction of the viewing performance of the user corresponding to the identification information, as the request, together with the identification information, from the advertisement delivery server 30. The request processing unit 107 searches the storage unit 11 for the viewing information associated with the acquired identification information, and extracts the information indicating the viewing performance of each broadcast advertisement content from the searched viewing information.

(Step S115)

The request processing unit 107 transmits the information indicating the extracted viewing performance of each broadcast advertisement content, to the advertisement delivery server 30 which is the transmission source of the request, as a response to the request.

(Step S117)

The delivery target specifying unit 303 acquires the information indicating the viewing performance of the broadcast advertisement content of the user indicated by the transmitted identification information, from the log management server 10, as a response to the request transmitted to the log management server 10. Thereby, the delivery target specifying unit 303 recognizes the viewing performance of each broadcast advertisement content by the user indicated by the identification information.

Thereafter, the delivery target specifying unit 303 specifies the web advertisement content of the delivery target to the user terminal 50 which is the acquisition source of the identification information, on the basis of the recognition result of the viewing performance of each broadcast advertisement content by the user indicated by the identification information.

Specifically, first, the delivery target specifying unit 303 extracts candidates of the advertisement content whose web advertisement content associated with the broadcast advertisement content is the delivery target, on the basis of a predetermined condition, from the recognition result of the viewing performance of each broadcast advertisement content.

As a more specific example, the delivery target specifying unit 303 extracts the candidates of the advertisement content whose web advertisement content is the delivery target, on the basis of the number of viewing times and the viewing time point of each broadcast advertisement content. Also, the delivery target specifying unit 303 may narrow down the candidates of the advertisement content whose web advertisement content is the delivery target, on the basis of the attribute information of the user corresponding to the identification information.

As described above, the delivery target specifying unit 303 extracts the candidates of the advertisement content whose web advertisement content is the delivery target, and specifies the advertisement content of the delivery target of the web advertisement content from among the extracted candidates.

Note that the delivery target specifying unit 303 may receive in advance a bidding from the advertiser for each advertisement content, and specify the advertisement content of the delivery target of the web advertisement content, on the basis of the information relevant to the bidding for each candidates, from among the candidates of the extracted advertisement content.

Upon specifying the advertisement content according to the viewing performance of each broadcast advertisement content, the delivery target specifying unit 303 specifies the web advertisement content corresponding to the advertisement content, as the delivery target to the user terminal 50 which is the acquisition source of the identification information. Then, the delivery target specifying unit 303 announces the information indicating the web advertisement content specified as the delivery target and the information of the user terminal 50 of the delivery destination of the web advertisement content, to the delivery control unit 305.

(Step S119)

The delivery control unit 305 receives an announcement indicating the information indicating the web advertisement content of the delivery target, and the information of the user terminal 50 of the delivery destination of the web advertisement content, from the delivery target specifying unit 303.

The delivery control unit 305 reads the data of the web advertisement content of the delivery target from the storage unit 31 on the basis of the announcement from the delivery target specifying unit 303. Then, the delivery control unit 305 delivers the data of the web advertisement content read from the storage unit 31, to the user terminal 50 announced from the delivery target specifying unit 303. Thereby, the user terminal 50 acquires the web advertisement content specified according to the viewing performance of the broadcast advertisement content of the user indicated by the identification information, as a reply to the identification information transmitted to the advertisement delivery server 30, from the advertisement delivery server 30.

(Step S121)

Also, the delivery control unit 305 may announce the information indicating the delivery performance (for example, the delivery date and time) of the web advertisement content, to the delivery performance recording unit 307 for each identification information.

The delivery performance recording unit 307 acquires the information indicating the delivery performance of each web advertisement content, for each identification information, from the delivery control unit 305, and records the acquired information indicating the delivery performance for each identification information.

Also, the delivery performance recording unit 307 transmits to the log management server 10 the information indicating the delivery performance of the web advertisement content recorded for each identification information, and requests the update of the viewing information based on the delivery performance to the log management server 10.

(Step S123)

It is assumed that the request processing unit 107 acquires the information indicating the delivery performance of the web advertisement content as well as the request of the update of the viewing information, for each identification information, from the advertisement delivery server 30. The request processing unit 107 extracts the viewing information associated with the identification information from the storage unit 11, and extracts the information indicating the viewing performance and the viewing prediction of the broadcast advertisement content associated with the web advertisement content whose delivery performance is acquired, from the extracted viewing information. Then, the request processing unit 107 updates the viewing information in such a manner that the acquired information indicating the delivery performance is associated with the information indicating the extracted viewing performance and viewing prediction. Thereby, the management of the viewing performance and the viewing prediction of the broadcast advertisement content and the delivery performance of the web advertisement content associated with the broadcast advertisement content is unified.

In the above, with reference to FIG. 4, an example of the sequence of a series of processes of the information processing system when delivering the corresponding web advertisement content to the user terminal 50 on the basis of the viewing performance of the past of the broadcast advertisement content has been described.

By the above control, for example, the advertisement delivery server 30 can control the delivery of the web advertisement content associated with the broadcast advertisement content, according to the viewing performance of the broadcast advertisement content by the user.

Thereby, for example, the advertisement delivery server 30 can control the number of deliveries of the web advertisement content, in such a manner that the summation of the number of user's encounters with each of the broadcast advertisement content and the web advertisement content related to the broadcast advertisement content becomes a predetermined number of times.

Also, as another example, the advertisement delivery server 30 can control the number of deliveries of the web advertisement content, in such a manner that the proportion of the number of user's encounters with the web advertisement content to the number of user's encounters with the broadcast advertisement content becomes a predetermined value.

Also, as another example, the advertisement delivery server 30 can control the web advertisement content delivering time point, in such a manner that the user encounters the web advertisement content associated with a certain broadcast advertisement content within a predetermined period from the user's encountering time point with the broadcast advertisement content.

{3.2. Control Example Based on Viewing Prediction}

Next, an example of the control by the information processing system when delivering the corresponding web advertisement content to the user terminal 50 on the basis of the viewing prediction of the broadcast advertisement content will be described.

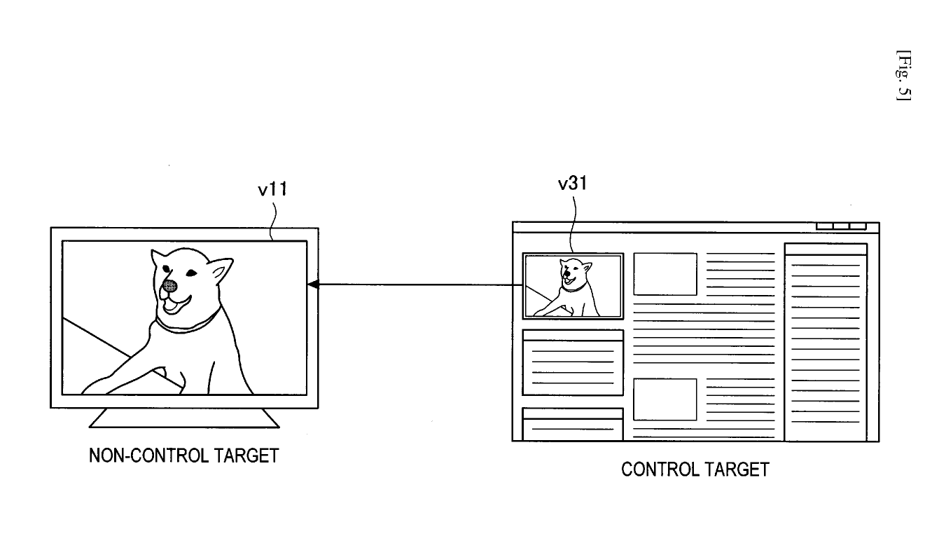

For example, FIG. 5 is an explanatory diagram for describing an example of the utilization situation of the information processing system according to the present embodiment, and illustrates an example when causing the user to encounter the corresponding web advertisement content on the basis of the viewing prediction of the broadcast advertisement content. That is, the information processing system according to the present embodiment causes the user who is predicted to view the broadcast advertisement content v11 to encounter the web advertisement content v31 associated with the broadcast advertisement content v11 beforehand, by the control described in this section. Thereby, as illustrated in FIG. 5, the information processing system can perform an indirect control in such a manner to cause the target user to encounter the broadcast advertisement content v11 broadcasted at a later date, after the encounter with the web advertisement content v31.

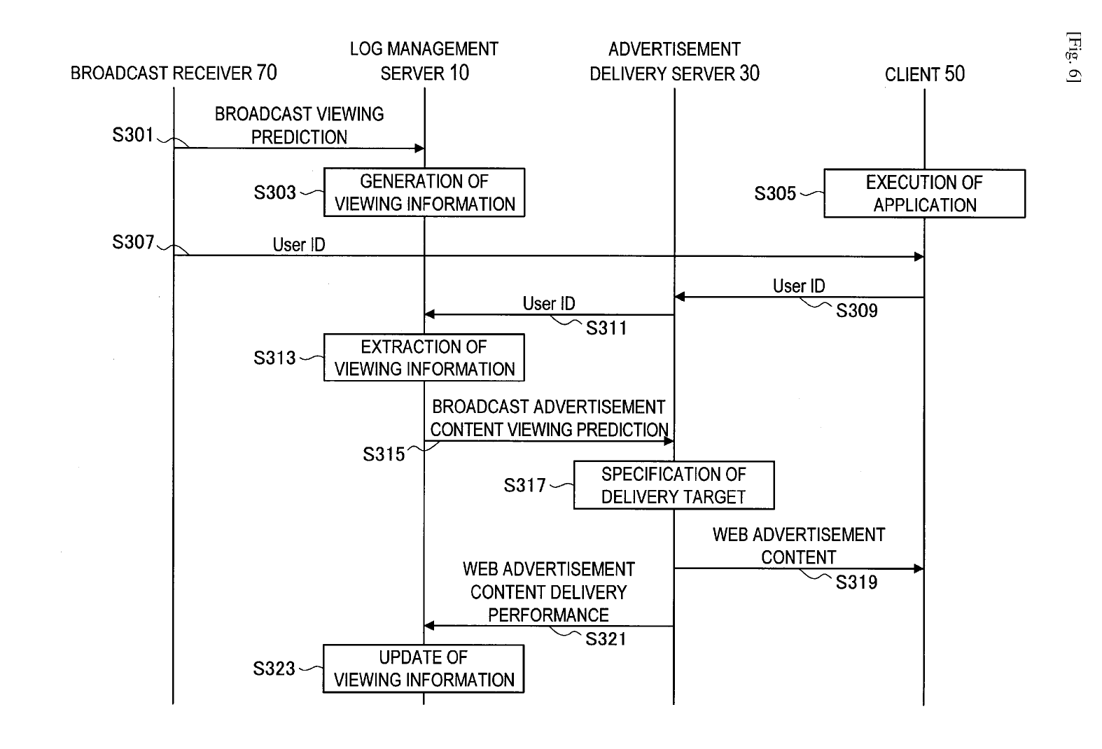

In the following, with reference to FIG. 6, an example of a sequence of a series of processes of the information processing system, when delivering the corresponding web advertisement content to the user terminal 50 on the basis of the viewing prediction of the broadcast advertisement content will be described. FIG. 6 is a flowchart illustrating another example of the sequence of a series of processes of the information processing system according to the present embodiment, and illustrates an example of the operation when delivering the corresponding web advertisement content on the basis of the viewing prediction of the broadcast advertisement content.

(Step S301)

The broadcast receiver 70 records, as record information, the information of the broadcast content that is predicted to be viewed by the user in future (i.e., the viewing prediction). As a specific example, the broadcast receiver 70 may record, as the record information, the information of the broadcast that is predicted to be viewed in future by the user, on the basis of the information of the broadcast habitually viewed by the user on the basis of the viewing history. Also, the broadcast receiver 70 may record, as the record information, the information of the broadcast that is predicted to be viewed in future by the user, on the basis of information of timer recording. The broadcast receiver 70 transmits the recorded record information (i.e., the viewing prediction of the broadcast advertisement content) to the log management server 10, in association with the identification information.

The collecting unit 103 of the log management server 10 acquires the record information (i.e., the viewing prediction of the broadcast content) managed by the broadcast receiver 70, and the identification information assigned to the broadcast receiver 70, from the broadcast receiver 70. The collecting unit 103 outputs the record information acquired from the broadcast receiver 70, to the viewing information generation unit 105, for each identification information.

(Step S303)

The viewing information generation unit 105 acquires the record information collected by the collecting unit 103 from the collecting unit 103 for each identification information. Also, the viewing information generation unit 105 reads the broadcast management information indicating the broadcast schedule of each broadcast advertisement content, which is stored in advance in the storage unit 11. Note that the broadcast schedule includes information indicating the broadcast date and time and the broadcast channel of the broadcast advertisement content that is scheduled to be broadcasted in future, for example.

The viewing information generation unit 105 generates or updates the viewing information including the viewing prediction of each broadcast advertisement content, on the basis of the record information acquired for each identification information and the broadcast management information read from the storage unit 11. Then, the viewing information generation unit 105 stores the generated or updated viewing information in the storage unit 11.

(Step S305)

The user terminal 50 acquires various types of content (for example, content posted on a web site or the like, etc.) via a network such as the Internet in response to the operation from the user, and executes various types of functions for presenting the acquired content to the user.

(Step S307)

Also, the broadcast receiver 70 announces the identification information assigned to itself, to the user terminal 50 associated in advance.

(Step S309)

The user terminal 50 acquires the identification information from the broadcast receiver 70, and transmits the acquired identification information to the advertisement delivery server 30.

(Step S311)

The delivery target specifying unit 303 of the advertisement delivery server 30 acquires the identification information corresponding to the user of the user terminal 50, from the user terminal 50 of the delivery target of the web advertisement content. The delivery target specifying unit 303 generates a request for acquiring the information indicating the viewing prediction of the broadcast advertisement content, by the user corresponding to the identification information, on the basis of the acquired identification information, and transmits the request to the log management server 10.

(Step S313)

The request processing unit 107 of the log management server 10 acquires the instruction of the extraction of the viewing prediction of the user corresponding to the identification information, as the request, together with the identification information, from the advertisement delivery server 30. The request processing unit 107 searches the storage unit 11 for the viewing information associated with the acquired identification information, and extracts the information indicating the viewing prediction of each broadcast advertisement content from the searched viewing information.

(Step S315)

The request processing unit 107 transmits the information indicating the extracted viewing prediction of each broadcast advertisement content, to the advertisement delivery server 30 which is the transmission source of the request, as a response to the request.

(Step S317)

The delivery target specifying unit 303 acquires the information indicating the viewing prediction of the broadcast advertisement content of the user indicated by the transmitted identification information, from the log management server 10, as a response to the request transmitted to the log management server 10. Thereby, the delivery target specifying unit 303 recognizes the viewing prediction of each broadcast advertisement content by the user indicated by the identification information.

Thereafter, the delivery target specifying unit 303 specifies the web advertisement content of the delivery target to the user terminal 50 which is the acquisition source of the identification information, on the basis of the recognition result of the viewing prediction of each broadcast advertisement content by the user indicated by the identification information.

Specifically, first, the delivery target specifying unit 303 extracts candidates of the advertisement content whose web advertisement content associated with the broadcast advertisement content is the delivery target, on the basis of a predetermined condition, from the recognition result of the viewing prediction of each broadcast advertisement content.

As a specific example, the delivery target specifying unit 303 extracts the candidates of the advertisement content whose web advertisement content is the delivery target, on the basis of the viewing time point of each broadcast advertisement content. As another specific example, the delivery target specifying unit 303 may extract the advertisement content for which the user's encounter with the broadcast advertisement content within a period determined in advance is predicted. By utilizing this extraction result, for example, a control is performed in such a manner that the user who is predicted to encounter the broadcast advertisement content encounters with the web advertisement content corresponding to the broadcast advertisement content in advance. Also, the delivery target specifying unit 303 may narrow down the candidates of the advertisement content whose web advertisement content is the delivery target, on the basis of the attribute information of the user corresponding to the identification information.

As described above, the delivery target specifying unit 303 extracts the candidates of the advertisement content whose web advertisement content is the delivery target, and specifies the advertisement content of the delivery target of the web advertisement content from among the extracted candidates.

Note that the delivery target specifying unit 303 may receive in advance a bidding from the advertiser for each advertisement content, and specify the advertisement content of the delivery target of the web advertisement content, on the basis of the information relevant to the bidding for each candidates, from among the candidates of the extracted advertisement content.

Upon specifying the advertisement content according to the viewing performance of each broadcast advertisement content, the delivery target specifying unit 303 specifies the web advertisement content corresponding to the advertisement content, as the delivery target to the user terminal 50 which is the acquisition source of the identification information. Then, the delivery target specifying unit 303 announces the information indicating the web advertisement content specified as the delivery target and the information of the user terminal 50 of the delivery destination of the web advertisement content, to the delivery control unit 305.

Note that the processes of below steps S319 to S323 are the same as the processes of steps S119 to S123 described above with reference to FIG. 4. Hence, their detailed description will be omitted.

In the above, with reference to FIG. 6, an example of the sequence of a series of processes of the information processing system when delivering the corresponding web advertisement content to the user terminal 50 on the basis of the viewing prediction of the broadcast advertisement content has been described.

By the above control, the advertisement delivery server 30 can perform a control in such a manner that the user who is predicted to view a certain broadcast advertisement content encounters the web advertisement content associated with the broadcast advertisement content beforehand, as illustrated in FIG. 5.

<4. Exemplary Variant>

Next, an exemplary variant of the information processing system according to the present embodiment will be described.

{4.1. Exemplary Variant 1: Example of Record Information}

First, an example of the information recorded as the record information will be described as an exemplary variant 1. In the information processing system according to the aforementioned embodiment, the log management server 10 specifies the viewing situation of the broadcast advertisement content, by verifying the broadcast date and time and the broadcast channel of the broadcast content recorded as the record information, against the broadcast date and time and the broadcast channel of the broadcast advertisement content recorded as the broadcast management information.

On the other hand, if the viewing situation (i.e., the viewing performance and the viewing prediction) of the broadcast advertisement content can be specified, the detail recorded as the record information by the broadcast receiver 70 is not limited to the information indicating the broadcast date and time and the broadcast channel necessarily.

As a specific example, the broadcast receiver 70 may record a feature value of the broadcast content (including the broadcast advertisement content) viewed by the user, as the record information. Note that the feature value of the broadcast content is a feature extractable from data, such as sound information (for example, voice, music, sound effect, etc.) and image information (for example, still image, moving image, etc.) included in the broadcast content.

In this case, the log management server 10 may recognize the viewing situation of the broadcast advertisement content, by verifying the feature value recorded as the record information against the feature value of the broadcast advertisement content acquired in advance.

Also, as another example, the broadcast receiver 70 may record the attribute information as the record information, when the attribute information is associated with the broadcast content (including the broadcast advertisement content).

In this case, the log management server 10 may recognize the viewing situation of the broadcast advertisement content, by verifying the attribute information recorded as the record information against the attribute information of the broadcast advertisement content acquired in advance.

In the above, an example of the information recorded as the record information has been described as the exemplary variant 1.

(4.2. Exemplary Variant 2: Example of Specifying Method of Delivery Target)

Next, as an exemplary variant 2, an example of an operation in which the advertisement delivery server 30 specifies the candidates of the web advertisement content of the delivery target, according to the viewing situation of the broadcast advertisement content, will be described. Specifically, the advertisement delivery server 30 is not limited to the viewing situation of a single piece of broadcast advertisement content, but may specify the web advertisement content of the candidates of the delivery target, according to the viewing situation of a plurality of pieces of broadcast advertisement content.

As a specific example, when a plurality of pieces of broadcast advertisement content is broadcasted for a specific article, the advertisement delivery server 30 may count the viewing situation of the plurality of pieces of broadcast advertisement content, and specify the web advertisement content of the candidates of the delivery target, according to the count result. As a more specific example, the advertisement delivery server 30 may calculate the summation of the number of viewing times of each of a plurality of pieces of broadcast advertisement content relevant to a specific article, and specify the web advertisement content of the candidates of the delivery target, in such a manner to control the number of times of presentation of the web advertisement content relevant to the article to the user, on the basis of the calculated number of times.

In this case, the advertisement delivery server 30 may classify the broadcast advertisement content of the count target in advance, and associate the web advertisement content with the classification in advance. Then, the advertisement delivery server 30 may analyze the viewing situation of the advertisement content included in the classification for each classification, and specify the web advertisement content of the candidates of the delivery target, according to the analysis result.

Note that, if the advertisement delivery server 30 can specify the web advertisement content of the candidates of the delivery target, according to the viewing situation of a plurality of pieces of broadcast advertisement content, the classification method of the plurality of pieces of broadcast advertisement content is not limited particularly.

As a specific example, the advertisement delivery server 30 may count the viewing situation of the broadcast advertisement content corresponding to each of a plurality of advertisers in cooperative business relationship, and specify the web advertisement content of the candidates of the delivery target, according to the count result.

Also, as another example, the advertisement delivery server 30 may count the viewing situation of the broadcast advertisement content (for example, the broadcast advertisement content of a competitor) relevant to an article of a specific type, and specify the web advertisement content of the candidates of the delivery target, according to the count result.

In the above, as an exemplary variant 2, the example of the operation in which the advertisement delivery server 30 specifies the candidates of the web advertisement content of the delivery target, according to the viewing situation of the broadcast advertisement content, has been described.

(4.3. Exemplary Variant 3: Utilization of Information Presented in Program)

Next, as an exemplary variant 3, an example in which the candidates of the web advertisement content of the delivery target are specified by utilizing the information relevant to the advertisement target presented in a program (i.e., broadcast content) will be described.

In the aforementioned embodiment, an example in which the advertisement delivery server 30 specifies the web advertisement content of the candidates of the delivery target, according to the viewing situation of the independent content of the broadcast advertisement content, has been described. On the other hand, in recent years, a section for introducing an article is provided in a program (broadcast content) in some cases, and the section plays the same role as the broadcast advertisement content.

Thus, the information processing system according to an exemplary variant 3 utilizes the user's encounter with the information relevant to the advertisement target presented in the program (in other words, the viewing situation of the information by the user), to specify the candidates of the web advertisement content of the delivery target.

As a specific example, the log management server 10 specifies the program viewed by the user on the basis of the record information (for example, the viewing history of the broadcast advertisement content) acquired from the broadcast receiver 70, and verifies the specification result against the information indicating the broadcast content of each program acquired in advance (i.e., the information relevant to the advertisement target presented in the program). Thereby, the log management server 10 can detect the user's encounter with the information relevant to the advertisement target presented in the program, and utilize it as the viewing situation of the information.

Also, as another example, the log management server 10 may specify the program viewed by the specified user on the basis of the record information, and detect the user's encounter with the information relevant to the advertisement target presented in the program, by analyzing the broadcast content of the specified program. As a more specific example, the log management server 10 may extract the sound indicating the advertisement target from the sound information, by analyzing the sound information broadcasted as the program, and detect the user's encounter with the information relevant to the advertisement target on the basis of the extraction result. Also, the log management server 10 may extract the advertisement target included in the video, by analyzing the video information broadcasted as the program, and detect the user's encounter with the information relevant to the advertisement target on the basis of the extraction result.

Also, as another example, when the information (for example, the attribute information) indicating the detail presented in the program is associated with the program, the log management server 10 may utilize the information. Specifically, the log management server 10 may extract the information related to the advertisement target from the information associated with the program, and detect the user's encounter with the information relevant to the advertisement target on the basis of the extraction result.

In the above, as the exemplary variant 3, an example in which the candidates of the web advertisement content of the delivery target are specified by utilizing the information relevant to the advertisement target presented in the program has been described. Note that the executor of each process described above is not limited to the log management server 10 necessarily. As a specific example, a component (for example, the advertisement delivery server 30) different from the log management server 10 may execute a part or all of each process described above.

(4.4. Exemplary Variant 4: Guidance to Broadcast Report Content)

Next, as an exemplary variant 4, an example of a control for guiding the user to encounter the broadcast advertisement content that is scheduled to be broadcasted in future will be described.

As described above, it is difficult to directly control the user's encounter with the broadcast advertisement content. In contrast, the information processing system according to the exemplary variant 4 guides to the user to encounter the broadcast advertisement content, by guiding the user in such a manner to view the program broadcasted together with the target broadcast advertisement content among the programs (i.e., the broadcast content) that is scheduled to be broadcasted in future.

As a specific example, the advertisement delivery server 30 according to the exemplary variant 4 specifies the target broadcast advertisement content on the basis of the information indicating the viewing situation of the broadcast advertisement content and a condition determined in advance.

Thereafter, the advertisement delivery server 30 specifies the program broadcasted together with the specified broadcast advertisement content, from among the programs that are scheduled to be broadcasted in future. Specifically, the advertisement delivery server 30 may acquire in advance the control information presenting the broadcast advertisement content broadcasted together with the program, for each program, and specify the program broadcasted together with the specified broadcast advertisement content on the basis of the control information.

Upon specifying the program of the target, the advertisement delivery server 30 guides the user to view the program, by delivering the information relevant to the specified program to the user terminal 50. As a specific example, the advertisement delivery server 30 may guide the user to view the program, by delivering the web advertisement content of the specified program to the user terminal 50.

Note that, if the user can be guided to view the program specified by the advertisement delivery server 30, the type of the information that the advertisement delivery server 30 delivers to the user terminal 50, and the method in which the user terminal 50 presents the information to the user are not limited particularly. As a specific example, if the user terminal 50 has a function for recommending the broadcast advertisement content as one function of a predetermined application, the user terminal 50 may operate to recommend the specified program preferentially to the user on the basis of the information from the advertisement delivery server 30. Although in the above an example has been describe in which the advertisement delivery server 30 delivers the information to the user terminal 50, the delivery destination of the information is not limited to the user terminal 50 necessarily, if the advertisement delivery server 30 can present the information to the user. As a specific example, the advertisement delivery server 30 may deliver the information to the broadcast receiver 70.

In the above, as the exemplary variant 4, an example of the control for guiding the user to encounter the broadcast advertisement content that is scheduled to be broadcasted in future has been described. By the above control, the advertisement delivery server 30 can guide the user to encounter the broadcast advertisement content broadcasted together with the program, by guiding the user to view the specified program.

<5. Working Example>

Next, a working example of the information processing system according to the present embodiment will be described. As described above, if the information processing system according to the present embodiment can cause the user to encounter the web advertisement content, its method and medium are not limited to what is called banner advertisement necessarily.

Thus, as a working example, an example will be described in which the information processing system according to the present embodiment delivers the web advertisement content (i.e., causes the user to encounter the web advertisement content) by utilizing the service which is called video on demand (VOD). Here, the VOD is a service that delivers the same video content via a network such as the Internet, so that the viewer can view the video content when the viewer wants to view it. Note that, in the following, the video content delivered by the VOD is sometimes referred to as “VOD content”.

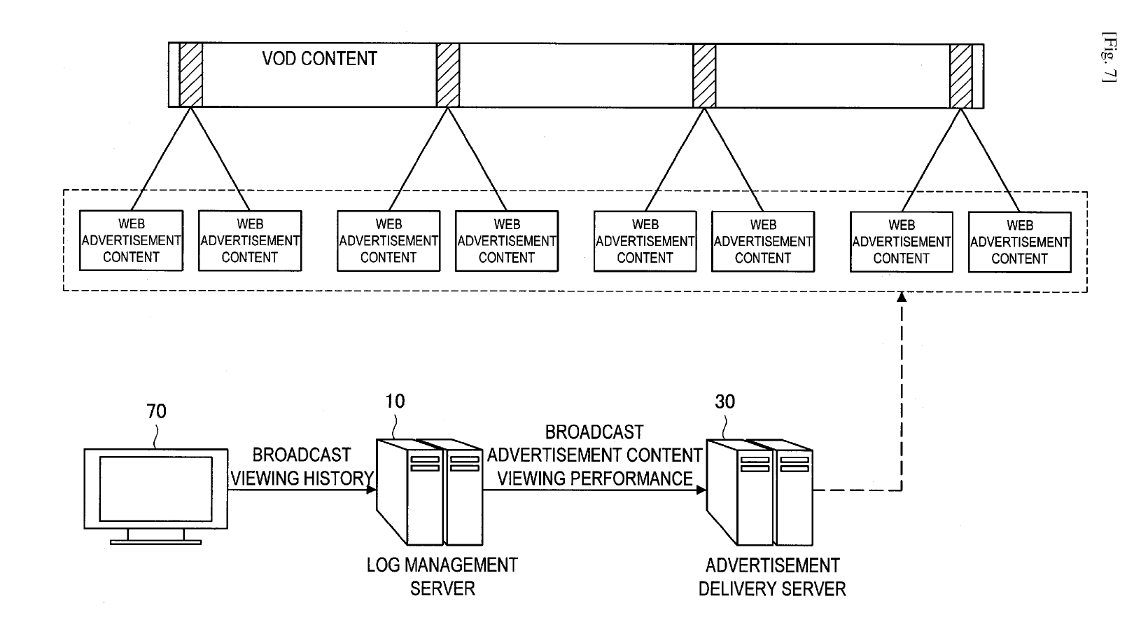

For example, FIG. 7 is an explanatory diagram for describing a working example of the information processing system according to the present embodiment, and illustrates an example in which the information processing system controls the web advertisement content presented in the VOD content delivered by the VOD.

As illustrated in FIG. 7, with regard to the VOD content, the advertisement content (in this case, the web advertisement content) can be inserted between the video content, in the same way as the broadcast content broadcasted by utilizing broadcast waves. Also, the VOD content is configured to control the advertisement content between the video content, in some cases. Thus, the information processing system according to the present embodiment may control the advertisement content (i.e., the web advertisement content) inserted in the VOD content, according to the viewing situation of the broadcast advertisement content by the user that views the VOD content, as illustrated in FIG. 7.

As illustrated in FIG. 7, as a specific example, the advertisement delivery server 30 acquires the viewing performance of the broadcast advertisement content which is generated on the basis of the viewing history of the broadcast content by the user (for example, the owner of the broadcast receiver 70) corresponding to the broadcast receiver 70 which is recorded in the broadcast receiver 70. Thereafter, the advertisement delivery server 30 specifies the web advertisement content on the basis of the viewing performance of the acquired broadcast advertisement content. Then, the advertisement delivery server 30 may control the web advertisement content inserted in the VOD content, in such a manner that the user who views the VOD content encounters the specified web advertisement content, according to the specification result of the web advertisement content.

Note that the control illustrated in FIG. 7 is just an example, and is not limited to the same control necessarily. As a specific example, the advertisement delivery server 30 may specify the web advertisement content inserted in the VOD content, on the basis of the viewing prediction of the broadcast advertisement content.

As a matter of course, the VOD content described above is just an example of the medium for causing the user to encountering the web advertisement content, and its type is not limited particularly if the medium can present the web advertisement content to the user via the network.

In the above, as the working example of the information processing system according to the present embodiment, an example in which the information processing system delivers the web advertisement content by utilizing the service which is called the VOD has been described with reference to FIG. 7.

<6. Hardware Configuration>

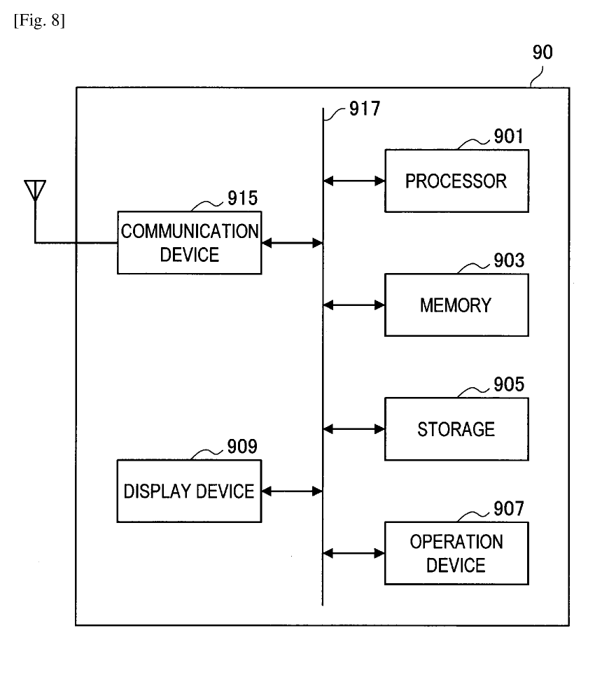

Next, with reference to FIG. 8, an example of the hardware configuration of the information processing apparatus 90, such as the log management server 10, the advertisement delivery server 30, and the user terminal 50 according to each embodiment of the present disclosure will be described. FIG. 8 is a diagram illustrating an example of the hardware configuration of the information processing apparatus 90 according to the embodiment of the present disclosure.

As illustrated in FIG. 8, the information processing apparatus 90 according to the present embodiment includes a processor 901, a memory 903, a storage 905, an operation device 907, a display device 909, a communication device 915, and a bus 917.

The processor 901 may be a central processing unit (CPU), a graphics processing unit (GPU), a digital signal processor (DSP), or a system on chip (SoC) for example, and executes various processes of the information processing apparatus 90. The processor 901 may be configure with an electronic circuit for executing various types of arithmetic processing, for example. Note that the collecting unit 103, the viewing information generation unit 105, and the request processing unit 107 in the aforementioned log management server 10 can be configured with the processor 901. In the same way, the delivery target specifying unit 303, the delivery control unit 305, and the delivery performance recording unit 307 in the aforementioned advertisement delivery server 30 can be configured with the processor 901.

The memory 903 includes a random access memory (RAM) and a read only memory (ROM), and stores programs and data executed by the processor 901. The storage 905 can include a storage medium, such as a semiconductor memory or a hard disk. Note that the aforementioned storage units 11 and 31 can be configured with at least one of the memory 903 and the storage 905 or a combination of the both.

The operation device 907 includes a function for generating an input signal for allowing the user to perform an intended operation. The operation device 907 can be configured as a touch panel, for example. Also, as another example, the operation device 907 may be configured with an input unit for allowing the user to input information, such as a button and a switch, and an input control circuit that generates an input signal on the basis of an input by the user and supplies it to the processor 901, for example.

The display device 909 is an example of an output device, and may be a device such as a liquid crystal display (LCD) device and an organic light emitting diode (OLED) display, for example. That is, the display device 909 announces predetermined information to the user, by displaying a screen image.

The communication device 915 is a communication mechanism included in the information processing apparatus 90, and communicates with an external device via a network. The communication device 915 is a communication interface for wired or the wireless communication. When the communication device 915 is configure as a wireless communication interface, the communication device 915 may include a communication antenna, a radio frequency (RF) circuit, and a baseband processor.

The communication device 915 has a function for performing various types of signal processing to the signal received from the external device, and is capable of supplying to the processor 901 the digital signal generated from the received analog signal. Note that the aforementioned communication unit 101 of the log management server 10 and the communication unit 301 of the advertisement delivery server 30 can be implemented by the communication device 915.

The bus 917 connects the processor 901, the memory 903, the storage 905, the operation device 907, the display device 909, and the communication device 915 with each other. The bus 917 may include a plurality of types of buses.

Also, a program for causing hardware such as a processor, a memory, and a storage in a computer to provide the same function as the above configuration of the information processing apparatus 90 can be created. Also, a computer readable storage medium storing the program can be provided.

<7. Conclusion>

The information processing system according to the present embodiment controls the delivery of the web advertisement content associated with the broadcast advertisement content, according to the viewing situation (i.e., the viewing performance or the viewing prediction) of each broadcast advertisement content. This configuration enables the information processing system according to the present embodiment to control the user's encounter with the related advertisement content, by controlling the delivery of the web advertisement content, even under the situation in which it is difficult to control the user's encounter with the broadcast advertisement content. Thereby, the information processing system according to the present embodiment allows the broadcast of the broadcast advertisement content and the delivery of the web advertisement content to cooperate more closely to cause the user to encounter the advertisement content more efficiently.

It should be understood by those skilled in the art that various modifications, combinations, sub-combinations and alterations may occur depending on design requirements and other factors insofar as they are within the scope of the appended claims or the equivalents thereof.

In addition, the effects described in the present specification are merely illustrative and demonstrative, and not limitative. In other words, the technology according to the present disclosure can exhibit other effects that are evident to those skilled in the art along with or instead of the effects based on the present specification.

Additionally, the present technology may also be configured as below.

(1) An information processing apparatus including:

circuitry configured to control: receiving first viewing information indicating a user viewing situation of a first advertisement content via broadcast signals determined from second viewing information using user identification information; and identifying a second advertisement content based on the first viewing information and a predetermined viewing time condition.

(2) The apparatus according to (1),

wherein the predetermined viewing time condition is a number of viewing times of the first advertisement content.

(3) The apparatus according to (1) or (2),

wherein the number of viewing times of the first advertisement content is equal to zero.

(4) The apparatus according to any one of (1) to (3),

wherein the number of viewing times of the first advertisement content is determined based on a series of viewing performances of the first advertisement content.

(5) The apparatus, according to any one of (1) to (4),

wherein the number of viewing times of the first advertisement content is determined based on viewing performances of the first advertisement content within a predetermined period.

(6) The apparatus according to any one of (1) to (5),

wherein the user viewing situation indicates at least one of a user viewing history or a user viewing prediction.

(7) The apparatus according to any one of (1) to (6),

wherein the predetermined viewing time condition is a number of viewing times of the first advertisement content that is less than a summation of viewing times of the first advertisement content and web advertisement content.

(8) The apparatus according to any one of (1) to (7),

wherein the predetermined viewing time condition is a proportion of a number of encounters with web advertisement content to a number of encounters with the first advertisement content.

(9) The apparatus according to any one of (1) to 8),

wherein the predetermined viewing time condition is a viewing time point of the first advertisement content.

(10) The apparatus according to any one of (1) to (9),

wherein the predetermined viewing time condition is elapsed time from an encountering time point with the first advertisement content that does not reach a predetermined period.

(11) The apparatus according to any one of (1) to (10),

wherein the predetermined viewing time condition is a predetermined period within which an encounter with the first advertisement content is predicted.

(12) The apparatus according to any one of (1) to (11),

wherein the second viewing information indicates broadcast management information of broadcast advertisement content.

(13) The apparatus according to any one of (1) to (12),

wherein the circuitry is configured to control outputting of information indicating delivery performance of the second advertisement content.

(14) The apparatus according to any one of (1) to (13),

wherein the second advertisement content is associated in advance with the first advertisement content.

(15) An information processing method including:

controlling, by a processing device, receiving first viewing information indicating a user viewing situation of a first advertisement content via broadcast signals determined from second viewing information using user identification information; and identifying a second advertisement content based on the first viewing information and a predetermined viewing time condition.

(16) An information processing apparatus including:

circuitry configured to control: extracting viewing information indicating a user viewing situation of a first advertisement content via broadcast waves, based on user identification information received by the apparatus; and outputting the viewing information for identifying a second advertisement content associated with the first advertisement content at a second apparatus, in which the second advertisement content is identified from the viewing information based on a predetermined viewing time condition.

(17) The apparatus according to (16),

wherein the predetermined viewing time condition is a number of viewing times of the first advertisement content.

(18) The apparatus according to (16) or (17),

wherein the viewing information indicates at least one of viewing performance or viewing prediction.

(19) The apparatus according to any one of (16) to (18),

wherein the circuitry is configured to control updating the viewing information based on information indicating delivery performance of the second advertisement content.

(20) An information processing apparatus including:

circuitry configured to control: transmitting, over a communication network, user identification information to a second apparatus, in which the second apparatus receives first viewing information indicating a user viewing situation of a first advertisement content via broadcast waves determined from second viewing information using the user identification information; and presenting, on a display device associated with the information processing apparatus, a second advertisement content received over the communication network, in which the second advertisement content is identified based on the first viewing information and a predetermined viewing time condition by the second apparatus.

(21) An information processing apparatus including:

an acquisition unit configured to acquire first information indicating a viewing situation of content broadcasted by using broadcast waves, from an external device associated with identification information, for each identification information;

a generation unit configured to generate second information indicating a viewing situation of first advertisement content, on the basis of the first information acquired for each identification information and information indicating a broadcast performance or a broadcast schedule of the first advertisement content broadcasted by using broadcast waves;

an extracting unit configured to extract the second information corresponding to a designated condition; and

an output unit configured to output the extracted second information, as information for specifying second advertisement content that is associated with the first advertisement content and delivered via a network.

(22) The information processing apparatus according to (21), wherein

the first information includes a viewing history of content broadcasted by using broadcast waves, and

the generation unit generates the second information indicating a viewing performance of the first advertisement content, by comparing the first information and the information indicating the broadcast performance of the first advertisement content.

(23) The information processing apparatus according to (21), wherein

the first information includes a viewing prediction of content broadcasted by using broadcast waves, and

the generation unit generates the second information indicating a viewing prediction of the first advertisement content, by comparing the first information and the information indicating the broadcast schedule of the first advertisement content.

(24) The information processing apparatus according to any one of (21) to (23), further including:

an update unit configured to update the second information, by associating a delivery situation of the second advertisement content which is announced for each identification information from an output destination of the second information, with a viewing situation of the first advertisement content associated with the second advertisement content.

(25) An information processing apparatus including:

an acquisition unit configured to acquire information indicating a viewing situation of first advertisement content broadcasted by using broadcast waves, on the basis of identification information acquired via a network from a client; and

a specifying unit configured to specify second advertisement content that is associated with the first advertisement content and delivered via a network, on the basis of the acquired information indicating the viewing situation.

(26) The information processing apparatus according to (25), wherein

the specifying unit extracts the second advertisement content of candidates of a delivery target to the client, on the basis of a condition determined in advance, from among the second advertisement content specified on the basis of the information indicating the viewing situation.

(27) The information processing apparatus according to (26), wherein

the specifying unit extracts, as the candidates, the second advertisement content associated with the first advertisement content whose number of viewing times satisfies a predetermined condition, from among the second advertisement content specified on the basis of the information indicating the viewing situation.

(28) The information processing apparatus according to (27), wherein

the specifying unit extracts, as the candidates, the second advertisement content associated with the first advertisement content whose number of viewing times is 0, from among the second advertisement content specified on the basis of the information indicating the viewing situation.

(29) The information processing apparatus according to any one of (26) to (28), wherein

the specifying unit extracts the candidates on the basis of attribute information of a user to which each second advertisement content is delivered and attribute information of a user associated with the identification information, from among the second advertisement content specified on the basis of the information indicating the viewing situation.

(30) The information processing apparatus according to any one of (26) to (29), wherein

the information indicating the viewing situation includes a viewing performance of the first advertisement content.

(31) The information processing apparatus according to (30), wherein

the specifying unit specifies the second advertisement content associated with the first advertisement content, according to a time point at which the first advertisement content is viewed, which is included in the information indicating the viewing situation.

(32) The information processing apparatus according to any one of (26) to (29), wherein

the information indicating the viewing situation includes a viewing prediction of the first advertisement content.

(33) The information processing apparatus according to (32), wherein

the specifying unit specifies the second advertisement content associated with the first advertisement content, according to a time point at which viewing of the first advertisement content is predicted, which is included in the information indicating the viewing situation.

(34) The information processing apparatus according to any one of (25) to (33), further including:

a delivering unit configured to deliver the specified second advertisement content to the client.

(35) The information processing apparatus according to (34), further including:

an announcing unit configured to associate the identification information and information including a delivery situation of the second advertisement content to the client of an acquisition source of the identification information, to announce the identification information and the information including the delivery situation of the second advertisement content, to an acquisition source of the information indicating the viewing situation.

(36) The information processing apparatus according to any one of (25) to (35), wherein

the specifying unit specifies other second advertisement content associated with the second advertisement content, when the second advertisement content associated with the first advertisement content is unable to be specified on the basis of the acquired information indicating the viewing situation.

(37) An information processing apparatus including:

an announcing unit configured to announce identification information acquired from an external device, to a server via a network; and

an acquisition unit configured to acquire, from the server via the network, second advertisement content associated with first advertisement content, which is specified on the basis of a viewing situation associated with the identification information, from among viewing situations of the first advertisement content broadcasted by using broadcast waves.

(38) An information processing method including:

announcing, by a processor, identification information acquired from an external device, to a server via a network; and

acquiring, by the processor, from the server via the network, second advertisement content associated with first advertisement content, which is specified on the basis of a viewing situation associated with the identification information, from among viewing situations of the first advertisement content broadcasted by using broadcast waves.

(39) A program for causing a computer to execute:

announcing identification information acquired from an external device, to a server via a network; and

acquiring, from the server via the network, second advertisement content associated with first advertisement content, which is specified on the basis of a viewing situation associated with the identification information, from among viewing situations of the first advertisement content broadcasted by using broadcast waves.

### REFERENCE SIGNS LIST

10 log management server

101 communication unit

103 collecting unit

105 viewing information generation unit

107 request processing unit

11 storage unit

30 advertisement delivery server

301 communication unit

303 delivery target specifying unit

305 delivery control unit

307 delivery performance recording unit

31 storage unit

50 user terminal

70 broadcast receiver

71 storage unit

80 broadcast station

90 information processing apparatus

1. An information processing apparatus comprising:
circuitry configured to control:
receiving first viewing information indicating a user viewing situation of a first advertisement content via broadcast signals determined from second viewing information using user identification information; and
identifying a second advertisement content based on the first viewing information and a predetermined viewing time condition.

2. The apparatus of claim 1, wherein the predetermined viewing time condition is a number of viewing times of the first advertisement content.

3. The apparatus of claim 2, wherein the number of viewing times of the first advertisement content is equal to zero.

4. The apparatus of claim 2, wherein the number of viewing times of the first advertisement content is determined based on a series of viewing performances of the first advertisement content.

5. The apparatus of claim 2, wherein the number of viewing times of the first advertisement content is determined based on viewing performances of the first advertisement content within a predetermined period.

6. The apparatus of claim 1, wherein the user viewing situation indicates at least one of a user viewing history or a user viewing prediction.

7. The apparatus of claim 1, wherein the predetermined viewing time condition is a number of viewing times of the first advertisement content that is less than a summation of viewing times of the first advertisement content and web advertisement content.

8. The apparatus of claim 1, wherein the predetermined viewing time condition is a proportion of a number of encounters with web advertisement content to a number of encounters with the first advertisement content.

9. The apparatus of claim 1, wherein the predetermined viewing time condition is a viewing time point of the first advertisement content.

10. The apparatus of claim 1, wherein the predetermined viewing time condition is elapsed time from an encountering time point with the first advertisement content that does not reach a predetermined period.

11. The apparatus of claim 1, wherein the predetermined viewing time condition is a predetermined period within which an encounter with the first advertisement content is predicted.

12. The apparatus of claim 1, wherein the second viewing information indicates broadcast management information of broadcast advertisement content.

13. The apparatus of claim 1, wherein the circuitry is configured to control outputting of information indicating delivery performance of the second advertisement content.

14. The apparatus of claim 1, wherein the second advertisement content is associated in advance with the first advertisement content.

15. An information processing method comprising:
controlling, by a processing device,
receiving first viewing information indicating a user viewing situation of a first advertisement content via broadcast signals determined from second viewing information using user identification information; and
identifying a second advertisement content based on the first viewing information and a predetermined viewing time condition.

16. An information processing apparatus comprising:
circuitry configured to control:
extracting viewing information indicating a user viewing situation of a first advertisement content via broadcast waves, based on user identification information received by the apparatus; and
outputting the viewing information for identifying a second advertisement content associated with the first advertisement content at a second apparatus, in which the second advertisement content is identified from the viewing information based on a predetermined viewing time condition.

17. The apparatus of claim 16, wherein the predetermined viewing time condition is a number of viewing times of the first advertisement content.

18. The apparatus of claim 16, wherein the viewing information indicates at least one of viewing performance or viewing prediction.

19. The apparatus of claim 18, wherein the circuitry is configured to control updating the viewing information based on information indicating delivery performance of the second advertisement content.

20. An information processing apparatus comprising:
circuitry configured to control:
transmitting, over a communication network, user identification information to a second apparatus, in which the second apparatus receives first viewing information indicating a user viewing situation of a first advertisement content via broadcast waves determined from second viewing information using the user identification information; and
presenting, on a display device associated with the information processing apparatus, a second advertisement content received over the communication network, in which the second advertisement content is identified based on the first viewing information and a predetermined viewing time condition by the second apparatus.
